(19) United States
(12) Patent Application Publication
(10) Pub. No.: US 2022/0091847 A1
(43) Pub. Date: Mar. 24, 2022

(54) PREFETCHING FROM INDIRECT BUFFERS AT A PROCESSING UNIT

(71) Applicant: ADVANCED MICRO DEVICES, INC., Santa Clara, CA (US)

(72) Inventors: Alexander Fuad ASHKAR, Orlando, FL (US); Harry J. WISE, Orlando, FL (US); Rex Eldon MCCRARY, Orlando, FL (US); Hans FERNLUND, Orlando, FL (US)

(21) Appl. No.: 17/029,841

(22) Filed: Sep. 23, 2020

(51) Int. Cl. G06F 9/30; G06F 9/38; G06F 9/54; G06F 13/16

(52) U.S. Cl. CPC G06F 9/30047; G06F 9/3814; G06F 13/1673; G06F 9/546; G06F 9/544

(57) ABSTRACT

In response to executing a specified command packet, a processing unit prefetches commands stored at an indirect buffer a command queue for execution, prior to executing a command that initiates execution of the commands stored at the indirect buffer. By prefetching the data prior to executing the indirect buffer execution command, the processing unit reduces delays in processing the commands stored at the indirect buffer.

### BACKGROUND

Modern processing systems typically employ multiple processing units to improve processing efficiency. For example, in some processing systems a central processing unit (CPU) executes general-purpose operations on behalf of the processing system while a graphics processing unit (GPU) executes operations associated with displayed image generation, vector processing, and the like. The CPU sends commands to the GPU to initiate the different image generation and other operations. To further enhance processor features such as program security, the GPU can be configured to implement indirect buffers to store commands associated with, for example, an individual program or device driver.

For example, in some cases a kernel mode driver employs a command ring buffer to store commands that manage overall operations at the GPU, and a user mode driver employs an indirect buffer to store commands associated with an executing application. To invoke execution of commands at an indirect buffer, the kernel mode driver stores a specified command, referred to as an indirect buffer execution command, or simply an indirect buffer command, at the command ring buffer. The indirect buffer execution command includes a includes a pointer or other reference to the indirect buffer, so that the GPU can, upon executing the indirect buffer command, initiate execution of the commands stored at the corresponding indirect buffer. Using indirect buffers allows the processing system to isolate commands associated with different drivers or applications to different regions of memory, enhancing system security and reliability.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system including a GPU that prefetches data for one or more indirect buffers in accordance with some embodiments.

FIG. 2 is a block diagram illustrating an example of the GPU of FIG. 1 prefetching data for an indirect buffer in accordance with some embodiments.

FIG. 3 is a block diagram illustrating an example of the GPU of FIG. 1 suppressing the on-demand fetching of data for an indirect buffer based on the status of a counter in accordance with some embodiments.

FIG. 4 is a block diagram illustrating an example of the GPU of FIG. 1 prefetching data for multiple indirect buffers based on a single prefetch command in accordance with some embodiments.

FIG. 5 is a block diagram illustrating an example of an indirect buffer prefetch packet in accordance with some embodiments.

### DETAILED DESCRIPTION

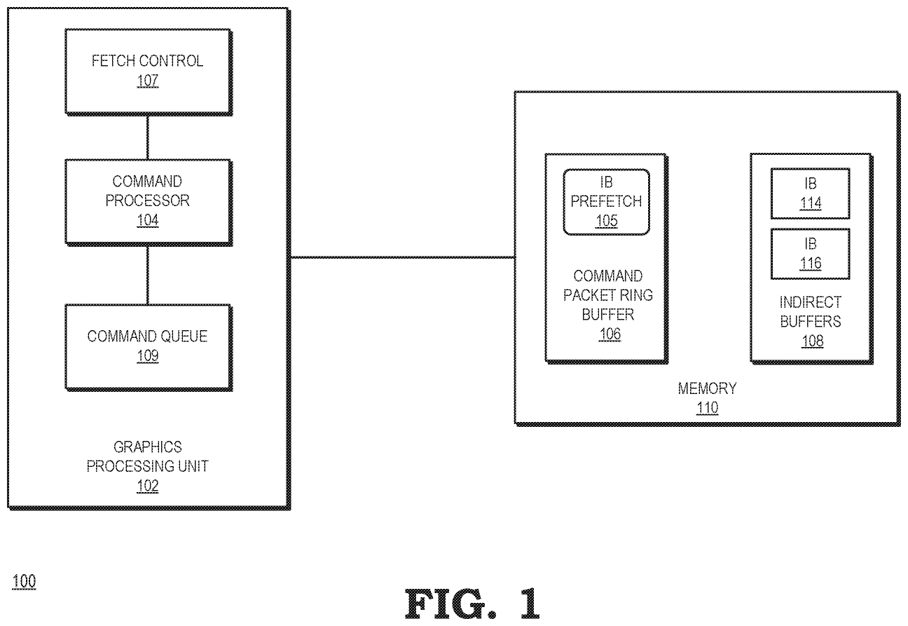

FIGS. 1-5 illustrate techniques for supporting prefetching of data for indirect buffers at a processing unit. In response to executing a specified command packet, referred to as an indirect buffer prefetch packet, the processing unit prefetches commands stored at an indirect buffer from a command queue for execution, prior to executing a command that initiates execution of the commands stored at the indirect buffer. By prefetching the data prior to executing the indirect buffer execution command, the processing unit reduces delays in processing the commands stored at the indirect buffer.

For example, in some embodiments a GPU receives commands from the CPU of a processing system, wherein the received commands include an indirect buffer prefetch packet requesting the prefetching of data for one or more indirect buffers. In response to the indirect buffer prefetch packet, the GPU fetches commands from the identified indirect buffers to a command queue. Subsequently the GPU processes an indirect buffer execution command, that causes the GPU to initiate execution of the commands associated with the indirect buffer. Because the commands for the indirect buffer have been prefetched to the command queue, the GPU can quickly begin processing the commands stored at the indirect buffer, thereby improving processing efficiency.

To illustrate further via an example, in some embodiments a GPU employs indirect buffers to store a sequence of commands associated with a specified program, such as a user mode driver. To initiate execution of the command sequence, a kernel mode driver stores an indirect buffer execution command at a command ring buffer of the GPU. Conventionally, when GPU identifies the indirect buffer execution command, a command processor of the GPU fetches the sequence of commands from the indirect buffer to a command queue for execution, a process referred to herein as “on demand” fetching. However, such on-demand fetching, in many cases, delays execution of the command sequence associated with the indirect buffer. Moreover, such execution delays sometimes take place during a time-sensitive phase of a program's execution, such as when the program is generating an image for display to a user. Using the techniques described herein, the GPU prefetches the sequence of commands for the indirect buffer prior to the GPU identifying the indirect buffer execution command at the command buffer. Accordingly, when the GPU executes the indirect buffer execution command, at least a portion of the command sequence has already been fetched to the command queue and therefore can be immediately executed, thereby enhancing processing efficiency and improving the user experience.

In some embodiments, the GPU employs a counter or other storage element to identify when data has been prefetched from a given indirect buffer to the command queue. When the GPU identifies an indirect buffer execution command at the command buffer, the GPU checks the storage element to determine if data has been prefetched from the indirect buffer. If so, the GPU suppresses fetching of data from the indirect buffer and instead begins processing data (e.g., executing a command sequence associated with the indirect buffer) from the command queue. If the storage element indicates that data has not been prefetched, the GPU first fetches the data from the indirect buffer to the command queue. The use of the counter, or other storage element, thereby allows the GPU to implement indirect buffer prefetching while still supporting existing drivers or other software.

In some embodiments, a single indirect buffer prefetch packet provides a list or other identifier of multiple indirect buffers for which prefetching is to be performed. When processing the indirect buffer prefetch packet, the GPU prefetches data from each of the multiple indirect buffers. The GPU thereby supports efficient prefetching of data from multiple indirect buffers, such as in cases where a program employs multiple indirect buffers storing short sequences of commands.

In some embodiments, the GPU implements an indirect buffer hierarchy having multiple levels of indirect buffers. The command packet buffer of the GPU's command processor forms the initial, or top, level of the hierarchy, and indirect buffer packets at the command packet buffer initiate access to a first indirect buffer level of the hierarchy. In some cases, commands stored at indirect buffers at the first indirect buffer level initiate access to indirect buffers at a second level of the hierarchy, and so on. In some embodiments, the GPU supports prefetching to multiple levels of the indirect buffer hierarchy. For example, in some embodiments the GPU prefetches data from indirect buffers at the first level and from indirect buffers at the second level in response to a single indirect buffer prefetch packet.

FIG. 1 illustrates a processing system 100 that supports prefetching from indirect buffers in accordance with some embodiments. The processing system 100 is generally configured to execute sets of instructions (e.g., computer programs or applications) to perform corresponding operations on behalf of an electronic device. Accordingly, in different embodiments the processing system 100 is incorporated in any of a variety of electronic devices, such as a desktop computer, a laptop computer, a tablet, a smartphone, a game console, a server, and the like. In the illustrated example, the processing system 100 includes a GPU 102 and a memory 110. In some embodiments, the processing system 100 includes additional modules not illustrated at FIG. 1, such as one or more CPUs, memory controllers, input output controllers, and the like, or any combination thereof to support execution of instructions on behalf of the electronic device.

The memory 110 is one or more memory modules or other storage devices configured to store data on behalf of the processing system 100. For example, in some embodiments the memory 110 represents system memory such as one or more dynamic random-access memory (DRAM) modules configured to store data accessible to a CPU of the processing system 100 as well as the GPU 102. In other embodiments, the memory 110 includes additional storage devices, such as one or more nonvolatile memory storage devices.

The GPU 102 is a processing unit generally configured to execute, on behalf of the processing system 100, operations associated with parallel processing of vector or matrix elements, including graphics operations, image generation, vector processing, and similar operations, or any combination thereof. To execute these operations, the GPU 102 includes one or more processing elements (not shown at FIG. 1), referred to as compute units (CUs), wherein each CU includes one or more single instruction multiple data (SIMD) modules or other processing elements to execute graphics operations, vector processing operations, and the like.

To execute operations at the GPU 102, a kernel mode driver (e.g., a driver associated with an operating system) stores command packets at a command packet ring buffer 106, located at the memory 110. To process the command packets, the GPU 102 includes a command processor 104, a fetch control module 107, and a command queue 109. The fetch control module 107 is generally configured to fetch commands from the memory 110 and store the fetched commands at the command queue 109. The command processor 104 proceeds through the command queue 109, decoding and executing each stored command in sequence. To illustrate, in response to accessing a command packet at the command queue 109, the command processor 104 decodes the command into a sequence of one or more command operations and executes the operations at the compute units. The command processor 104 then proceeds to the next command packet stored at the command queue 109, processing each command packet in turn, thereby carrying out the one or more operations indicated by the sequence of command packets. For example, in some embodiments, based on the sequence of command packets the command processor 104 schedules sets of operations, referred to as wavefronts, to be executed at the one or more compute units of the GPU 102.

In the illustrated embodiment, the GPU 102 employs two types of structures, located at the memory 110, to store command packets for execution. As noted above, a kernel mode driver stores commands on behalf of an operating system or other system management program at a command packet ring buffer 106. In addition, one or more user mode drivers or other programs store command packets for execution at a set of indirect buffers, designated indirect buffers 108. Execution of the command packets at an indirect buffer is invoked via a specified command packet, referred to as an indirect buffer command packet, indicating the corresponding indirect buffer. To illustrate via an example, the fetch control module 107 initially fetches command packets from the command packet ring buffer 106 to the command queue 109. The command processor 104 executes the fetched command packets in sequence. Upon executing an indirect buffer execution command, the command processor 104 is redirected, as described further herein, to execute the sequence of command packets associated with the indicated indirect buffer. The command processor 104 executes the indirect buffer command sequence and, upon executing the final command in the sequence, returns to executing commands fetched from the command packet ring buffer 106.

For example, in some embodiments the command queue includes different regions, including a region associated with the command packet ring buffer 106 and regions associated with each of the indirect buffers 109. The command processor 104 employs a register or other storage element that stores a pointer (referred to herein as a command pointer) to the next command packet at the command queue 109 to be processed by the modules of the command processor 104. During an initialization of the command processor 104, the command pointer is set to an initial entry of the region associated with the command packet ring buffer 106. As the command processor 104 processes a packet at an entry of the command queue 109, the command pointer value is incremented, or otherwise adjusted, to point to a next entry of the command queue 109.

In response to an entry of the command queue 109 storing an indirect buffer packet, the command processor 104 sets the value of the command pointer to point to an initial entry of the region the command queue 109 corresponding to the indirect buffer. The command processor 104 executes the commands at the specified region, as fetched from the indirect buffer, in sequence until reaching a final entry associated with the indirect buffer. After processing the command at the final entry, the command processor 104 sets the command pointer to the next entry of the region associated with the command packet ring buffer 106 (that is, the next entry after the processed indirect buffer packet). The command processor 104 thereby returns to processing commands fetched from the command packet ring buffer 106.

Conventionally, a GPU does not initiate fetching of packets from an indirect buffer to the command queue 109 until the command processor 104 executes the indirect buffer packet for that indirect buffer. However, this arrangement will sometimes cause the command processor 104 to stall, or otherwise operate inefficiently, while awaiting the fetching of packets from the indirect buffer. Accordingly, to enhance processing efficiency the fetch control module 107 is configured to prefetch data, from one or more of the indirect buffers 108 so that at least some of the commands associated with the indirect buffers are stored at the command queue 109 when the indirect buffer packet for that indirect buffer is executed by the command processor 104. For example, in some embodiments one of the commands stored at the command packet ring buffer 106 is an explicit indirect buffer prefetch command packet, designated D3 prefetch packet 105. In response to identifying the IB prefetch packet 105 at the command queue 109, the command processor 104 instructs the fetch control module 107 to prefetch data from one or more of the indirect buffers 108 to the command queue 109. In some embodiments, the D3 prefetch packet 105 includes one or more fields identifying the data to be prefetched from each of the indirect buffers 108. In other embodiments, the IB prefetch packet stores a pointer to a list (not shown) stored at the memory 110, wherein the list sets forth the data to be prefetched from each of the indirect buffers 108.

In the depicted embodiment, the indirect buffers 108 includes an indirect buffer 114 and an indirect buffer 116. In operation, in response to the command processor 104 identifying the IB prefetch packet 105 for the indirect buffer 114, the fetch control module 107 prefetches data from the indirect buffer 114 to the command queue 109. Subsequently, the command processor 104 executes an indirect buffer packet for the indirect buffer 114. In response to the indirect buffer packet, the command processor 104 identifies that the data has been prefetched from the indirect buffer 114 and therefore does fetch the data from the indirect buffer 114 in an on-demand fashion. Instead, the command processor 104 immediately begins executing the sequence of commands fetched from the indirect buffer 114 and stored at the command queue 109. In contrast, in response to the indirect buffer packet a conventional GPU would first need to fetch the data from the indirect buffer 114 to the command queue 109, thereby delaying execution of the command sequence and reducing processing efficiency.

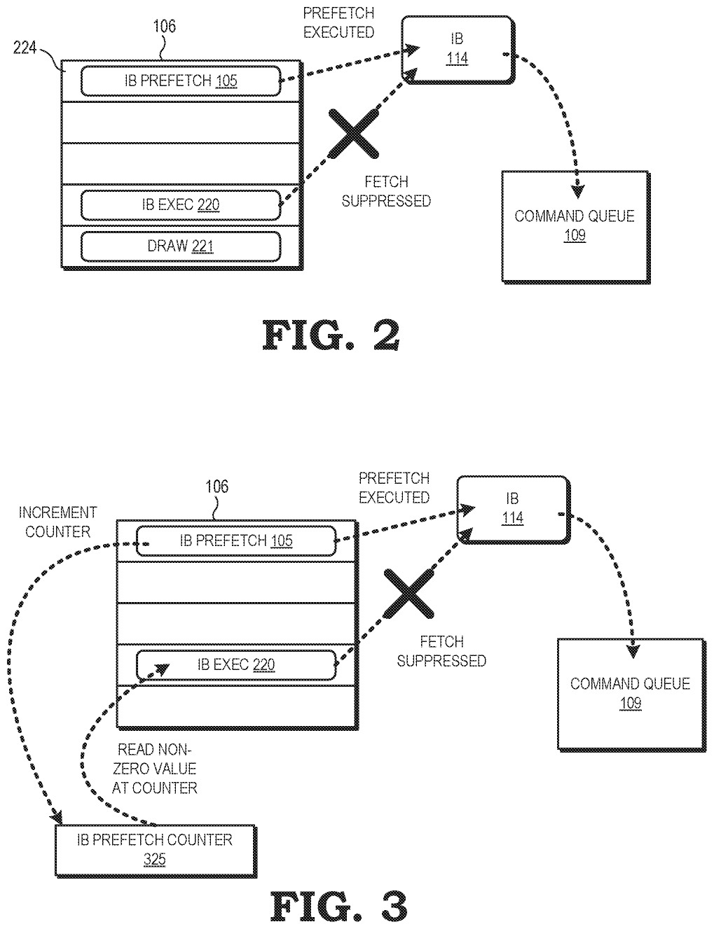

FIG. 2 illustrates an example of the GPU 102 prefetching data from an indirect buffer in accordance with some embodiments. In the illustrated example, the command processor 104 identifies the IB prefetch packet 105 for the indirect buffer 114 at an entry 224 of the command packet ring buffer 106. In response, the fetch control module 107 prefetches data 112 from the indirect buffer 114 stored in memory 110 to command queue 109.

Subsequently, in the course of executing the command packets fetched from the command packet buffer 106, the command processor 104 identifies an indirect buffer packet 220 that instructs the command processor 104 to begin executing the commands stored at the indirect buffer 114. In response to the indirect buffer execute packet 220, the command processor 104 suppresses fetching of the data 112 from the memory 110, as the data 112 has already been prefetched from the indirect buffer 114 to the command queue 109. In some embodiments, the command processor 104 suppresses the fetching by preventing the fetch control module 107 of the command processor 104 from fetching data identified by the indirect buffer execute packet 220. By prefetching the commands from the indirect buffer 114, the command processor 104 is able to more quickly begin executing a draw command represented by a packet 221. In contrast, in response to the indirect buffer execute packet 220 a conventional GPU would first fetch the data 112 to the indirect buffer 114, thus delaying execution of the draw command 221.

In some embodiments, to accommodate existing programming models, including existing device drivers, the GPU 102 selectively fetches data to an indirect buffer in an on-demand fashion based on the status of a data prefetch indicator for the indirect buffer. An example is illustrated at FIG. 3 in accordance with some embodiments. In the depicted example, the GPU 102 includes a prefetch counter 325. In response to prefetching data from the indirect buffer 114, the command processor 104 increments the prefetch counter 325 to indicate that the data has been prefetched. Based on the state of the prefetch counter 325, the command processor 104 determines whether to fetch data in response to an indirect buffer packet for the indirect buffer 114. In particular, if the prefetch counter 325 has a non-zero value that indicates that data has been prefetched from the indirect buffer 114 the command processor 104 suppresses subsequent fetches for indirect buffer packets associated with the indirect buffer 114. If the prefetch counter 325 has a zero value, indicating that no data has been prefetched to the indirect buffer 114, the command processor 104 fetches data from the indirect buffer 114 in response to the indirect buffer execute packet 220.

To illustrate via an example, in response to the IB prefetch packet 105, the fetch control module 107 prefetches data from the indirect buffer 114 to the command queue 109. In addition, the fetch control module 107 increments the prefetch counter 325, indicating that data has been prefetched from the indirect buffer 114. Subsequently, when the command processor identifies the indirect buffer execute packet 220, the command processor 104 determines the state of the prefetch counter 325. In response to determining that the value at the prefetch counter 325 is a non-zero value, the command processor 104 suppresses fetching of data from the indirect buffer 114.

In contrast, if a device driver does not implement prefetching, the prefetch packet 105 is not stored at the command packet ring buffer 106, and therefore the value of the prefetch counter 325 remains at its initial value of zero. Accordingly, when the indirect buffer execute packet 220 is processed, the command processor 104 determines based on the state of the prefetch counter 325 that prefetching has not taken place, and therefore fetches the data from the indirect buffer 114. The GPU 102 thus supports both device drivers that implement indirect buffer prefetching as well as device drivers that do not implement such prefetching.

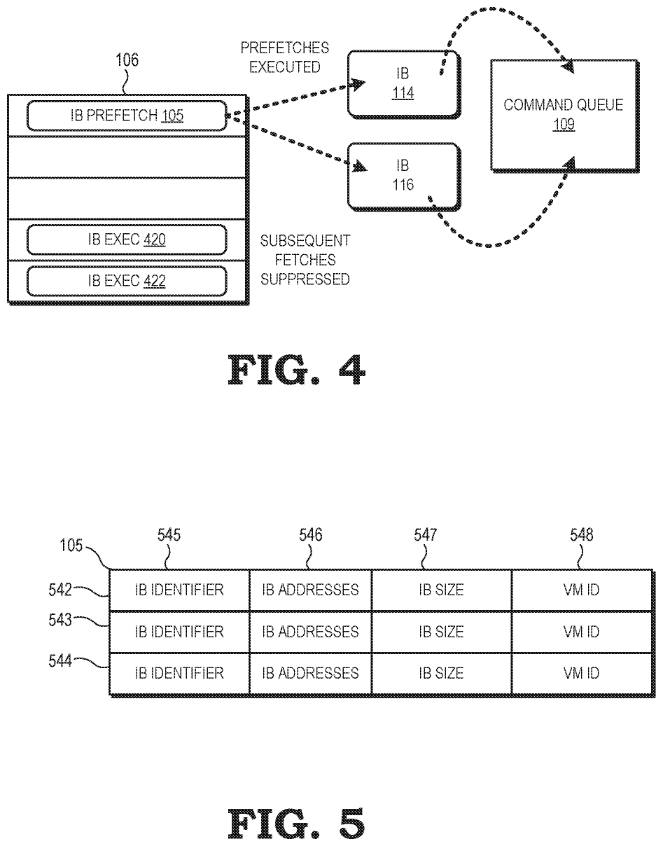

In some embodiments, the indirect buffer prefetch packet 105 identifies multiple indirect buffers for prefetching. An example is illustrated at FIG. 4 in accordance with some embodiments. In the illustrated example, the indirect buffer prefetch packet 105 identifies data to be prefetched from the indirect buffer 114, and also identifies different data to be prefetched from the indirect buffer 116. Accordingly, in response to identifying the indirect buffer prefetch packet 105, the command processor 104 instructs the fetch control module 107 to prefetch data from the indirect buffer 114 and to prefetch data from the indirect buffer 116.

In the depicted example, the command packet ring buffer 106 stores indirect buffer packets 420 and 422 corresponding to indirect buffer 114 and indirect buffer 116, respectively. Upon identifying the indirect buffer packet 420, the command processor 104 determines that data has been prefetched and therefore suppresses fetching the data in response to the indirect buffer packet 420. Instead, the command processor immediately begins executing the command packets prefetched from the indirect buffer 114. Similarly, in response to identifying the indirect buffer packet 422, the command processor 104 determines that data has been prefetched from the indirect buffer 116 and therefore suppresses fetching the data in response to the indirect buffer packet 422. Instead, the command processor 104 immediately begins executing the command packets prefetched from the indirect buffer 116. Thus, in the example of FIG. 4, a single indirect buffer prefetch packet 105 causes the fetch control module 107 to prefetch data from multiple indirect buffers, allowing the GPU 102 to suppress or omit fetching of data in an on-demand fashion for each of these indirect buffers, further improving processing efficiency.

FIG. 5 illustrates an example of the indirect buffer prefetch packet 105 in accordance with some embodiments. In the example of FIG. 5, the indirect buffer prefetch packet 105 includes a plurality of entries, including entries 542, 543, 544. Each of the plurality of entries corresponds to a different indirect buffer and includes a plurality of fields describing characteristics of the data to be prefetched to the corresponding indirect buffer.

In particular, each of the entries 542, 543, 544 includes an identifier field 545, an addresses field 546, an indirect buffer size field 547, and a virtual memory identifier field 548. The identifier field 545 stores an identifier for the indirect buffer corresponding to the entry. Thus, for example the identifier field 545 of the entry 540 stores an identifier for the indirect buffer corresponding to the entry 540. The addresses field 546 stores one or more memory addresses identifying corresponding memory locations of the memory 110 from which data is to be prefetched. The indirect buffer size field 547 identifies the size of the indirect buffer corresponding to the entry. The virtual memory identifier field 548 indicates the virtual memory associated with the indirect buffer corresponding to the entry.

In response to identifying the indirect buffer prefetch packet 105 at the command packet ring buffer 106, the command processor 104 uses each of the entries 540, 541, and 542 to prefetch data from the corresponding indirect buffer. For example, in some embodiments the command processor prefetches data from the memory 110 at the memory address indicated by the addresses field 546. The command processor 104 maintains a table or other data structure for the indirect buffers, and stores both the value of the identifier field 545, and the value for the virtual memory identifier field 548 at the table or other data structure for subsequent use. The command processor 104 employs the indirect buffer size field 147 to identify an end or final entry of the corresponding indirect buffer, and stops prefetching data from the indirect buffer at identified final entry.

In some embodiments, the entries 542, 543, 544 are not stored at the IB prefetch packet 105 itself. Instead, the entries 542, 543, 544 are placed in a list or other data structure, and the data structure is stored at a memory location of the memory 110 by a device driver or other module. The IB prefetch packet 105 is configured by the device driver or other module to store a pointer to the memory location that stores the data structure. In response to identifying the D3 packet 105, the command processor 104 uses the pointer to access the list at the memory 110, and the fetch control module 107 employs the list to prefetch data to the different IB buffers 108.

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving a first indirect buffer prefetch packet at a command processor of a processing unit; and
in response to receiving the first indirect buffer prefetch packet, prefetching data from a first indirect buffer indicated by the first indirect buffer prefetch packet to a command queue prior to executing an indirect buffer packet for the indirect buffer.

2. The method of claim 1, wherein the first indirect buffer prefetch packet indicates a plurality of indirect buffers.

3. The method of claim 2, further comprising:
in response to the first indirect buffer prefetch packet, prefetching data from each of the plurality of indirect buffers.

4. The method of claim 1, wherein the processing unit implements a plurality of indirection levels, and wherein the first indirect buffer prefetch packet indicates a selected level of the plurality of indirection levels.

5. The method of claim 4, wherein prefetching data from the first indirect buffer comprises prefetching data from an indirect buffer at the selected level of the plurality of indirection levels.

6. The method of claim 1, further comprising:
in response to identifying, at the command processor, the indirect buffer packet for the first indirect buffer, suppressing fetching of data from the indirect buffer.

7. The method of claim 6, further comprising:
setting an indicator in response to prefetching the data from the first indirect buffer; and
suppressing the fetching in response to identifying that the indicator is set.

8. The method of claim 1, wherein the first indirect buffer prefetch packet indicates a size of the first indirect buffer.

9. The method of claim 1, wherein the first indirect buffer prefetch packet indicates a plurality of indirect buffers for prefetching.

10. A method, comprising:
receiving, at a command processor of a processing unit, a prefetch packet indicating a list of indirect buffers; and
in response to receiving the prefetch packet, prefetching data from each of a plurality of indirect buffers indicated by the list to a command queue associated with the command processor.

11. The method of claim 10, wherein:
receiving the prefetch packet comprises receiving the prefetch packet from a first indirect buffer; and
prefetching data comprises prefetching data from a second indirect buffer different from the first indirect buffer.

12. The method of claim 11, wherein the first indirect buffer is associated with a first indirect buffer level of the processing unit and the second indirect buffer is associated with a second indirect buffer level of the processing unit.

13. A processing unit comprising:
a command queue;
a command processor to receive a first indirect buffer prefetch packet from the command queue; and
a fetch controller to, in response to the first indirect buffer prefetch packet, prefetch data from a first indirect buffer indicated by the first indirect buffer prefetch packet to the command queue prior to the command processor executing an indirect buffer packet for the indirect buffer.

14. The processing unit of claim 13, wherein the first indirect buffer prefetch packet indicates a plurality of indirect buffers.

15. The processing unit of claim 14, wherein the fetch controller is to:
in response to the first indirect buffer prefetch packet, prefetching data from each of the plurality of indirect buffers.

16. The processing unit of claim 13, wherein the processing unit implements a plurality of indirection levels, and wherein the first indirect buffer prefetch packet indicates a selected level of the plurality of indirection levels.

17. The processing unit of claim 16, wherein the fetch controller is to prefetch data from an indirect buffer at the selected level of the plurality of indirection levels.

18. The processing unit of claim 13, wherein the command processor is to:
in response to identifying the indirect buffer packet at the command queue, suppressing of fetching of data from the indirect buffer.

19. The processing unit of claim 18, further comprising:
a storage element to store an indicator in response to the fetch controller prefetching the data to the first indirect buffer; and
wherein the command processor is to suppress fetching of data from the indirect buffer in response to identifying that the indicator is set.

20. The processing unit of claim 13, wherein the first indirect buffer prefetch packet indicates a size of the first indirect buffer.
